(19) United States
(12) Patent Application Publication
(10) Pub. No.: US 2011/0047131 A1
(43) Pub. Date: Feb. 24, 2011

(54) MEDIA PLAYBACK METHOD FOR A PORTABLE DEVICE AND PORTABLE DEVICE THEREOF

(76) Inventor: Shih-Chia Huang, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/559,509

(22) Filed: Sep. 15, 2009

(30) Foreign Application Priority Data
Aug. 21, 2009 (TW) 098128188

(51) Int. Cl. G06F 17/30; G06F 12/08; G06F 12/02

(52) U.S. Cl. 707/694; 711/103; 711/118; 707/E17.009; 707/E17.044; 711/E12.008; 711/E12.017

(57) ABSTRACT

Before a portable device playbacks the media files or during the playback of one media file, a rule of generating a playlist is selected first by operating a user's interface of the portable device or by the portable device's default setting. The playlist including some multiple media files is then generated according to an anchor file and the selected rule. A rule for how to play the media files in the playlist is selected (or by system's default setting if not selected) to decide the playing sequence of the media files in the playlist from the anchor file.

### BACKGROUND OF THE INVENTION

1. Field of the Invention

The invention relates to a media playback method and a portable device that uses the media playback method for playing media files, and more particularly, to a directory-based media playback method and the portable device thereof.

2. Description of the Prior Art

It has been evolving as a primary trend for portable devices such as mobile phones, walkmans, personal digital assistants (PDA), or mobile multimedia devices to provide versatile experiences for the consumers by enhancement with multimedia playback functions. These portable devices have also gain much support for various types of media. Most portable devices, as far as the users using an MP3 player and playing music files with MP3 format is concerned, play the media files by referring to a playlist that contains information of one or more media files.

Generally the playlist is generated by one of the following ways:

1. The playlist is generated by using ID3 information embedded in each media file. The user selects media files by choosing some built-in attributes such as album name, artist, year of release, genres, etc, and the portable device puts together all the media files that are selected by the user and have the same attribute and lists them in the playlist. The ID3 information of these media files, however, must be input along with the media files, or before the media files are looked up by the portable device. Such media database that contains ID3 information requires to be pre-established before the portable device can use the media files.

2. The playlist is generated on the basis of directory-based file system. The most popular directory-based file system can be used to build the structural relations of the media files in that a whole-field playlist that includes listing of all media files in the portable device can be generated after the user selected one specific media file, from which to begin the playback of all the media files listing in the playlist. Such directory-base playlist generation method simply lacks of flexibility of alternatives because users can do nothing but use only one generated playlist.

3. The playlist may also be generated/edited by the user beforehand, according to user's preferences to select any media file in the portable device by his/her will. The playlist may also contain user-defined playback sequence of the selected media files. Although highly flexibility to include media files into the playlist, such playlist generation method requires extra effort of the user to select media files one by one before the playlist is fully usable. The playlist generated by this way also leaves little room for modified any time the user wants to, especially when the portable device is working.

### SUMMARY OF THE INVENTION

The invention provides a media playback method for a portable device containing a plurality of media files. The method comprises following steps: selecting an anchor file from the plurality of media files; selecting a first listing rule from a playlist rule database; generating a playlist by selecting media files from the plurality of media files according to the anchor file and the first listing rule; and using the portable device to play the media files listing in the playlist according to a playback rule. The plurality of media files, the first listing rule, the playback rule, the playlist, and the playlist rule database are stored in a memory unit of the portable device. The portable device stores the plurality of media files based on a file directory system. The playlist rule database comprises at least one listing rule from the following listing rules: selecting media files in same folder including subfolders as the anchor file, selecting media files in sibling folders according to the anchor file, and selecting media files in sibling folders including subfolders according to the anchor file.

The invention also provides a portable device. The portable device comprises a memory unit and a processing unit. The memory unit stores a plurality of media files, a first listing rule, a first playback rule, and a playlist rule database. The processing unit is used for selecting an anchor file from the plurality of media files, generating a playlist by selecting media files from the plurality of media files according to the anchor file and the first listing rule, and playing the media files listing in the playlist according to the first playback rule, wherein the playlist is stored in the memory unit. The plurality of media files is stored in the memory unit based on a file directory system. The playlist rule database comprises at least one listing rule from the following listing rules: selecting media files in same folder including subfolders as the anchor file, selecting media files in sibling folders according to the anchor file, and selecting media files in sibling folders including subfolders according to the anchor file.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram showing steps of a media playback method for a portable device according to the invention.

FIG. 2 is a block diagram of the portable device.

FIG. 3 is a block diagram of a first memory of the portable device.

FIG. 4 is a block diagram of a second memory of the portable device.

FIG. 5 is a schematic diagram showing a plurality of media files stored in the portable device based on a file-directory system.

FIG. 6 is a schematic diagram showing multiple playlists generated by use of the media playback method according to the invention.

FIG. 7 is a schematic diagram showing the workflow of the media playback method on the portable device.

### DETAILED DESCRIPTION

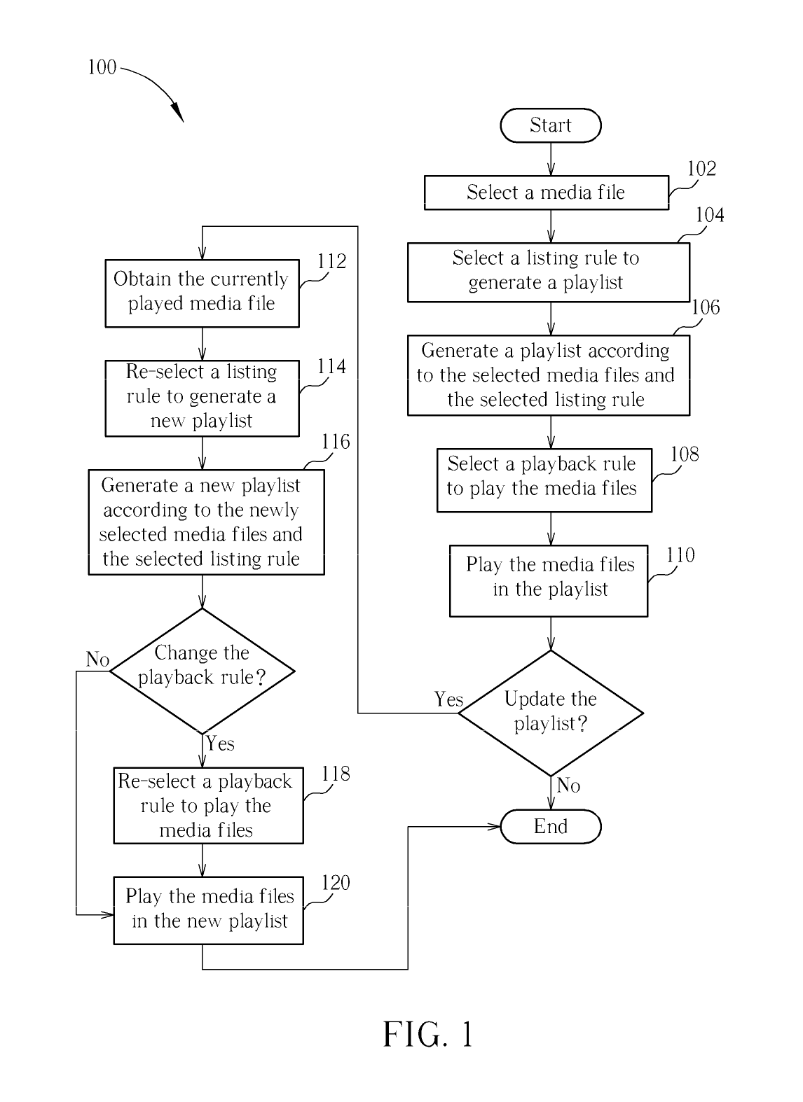

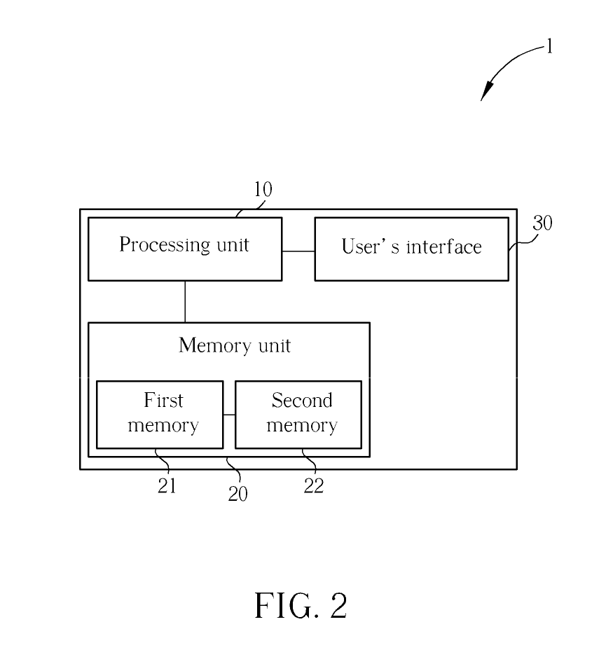

Please refer to FIG. 1 and FIG. 2. FIG. 1 is a schematic diagram showing steps of a media playback method 100 for a portable device 1 according to the invention. FIG. 2 is a block diagram of the portable device 2. The portable device 1 in the invention may be a music player, a personal digital assistant (PDA), a mobile phone, a smart phone, a portable navigation device (PND), or any types of portable media playback device. The portable device 1 includes a processing unit 10, a memory unit 20, and a user's interface 30. More than one and multiple types of media files such as music files (compressed form or uncompressed form music files, voice files, recording files), still image files (images, pictures), and motion image files (movies, clips, briefing files) may be stored in the memory unit 20. The user's interface 30 may be buttons, touch screen, sensor, or signal receiver of the portable device 1, used for receiving or inputting instructions to control the processing unit 10 to playback one or more media files stored in the memory unit 20. The memory unit 20 may also includes a first memory 21 and a second memory 22; practically, the first memory 21 can be implemented with a non-volatile memory such as a flash memory mainly used for storing such various types of media files, and the second memory 22 can also be implemented with a non-volatile memory or a volatile memory used for storing temporarily-generated file during operation of the portable device 1.

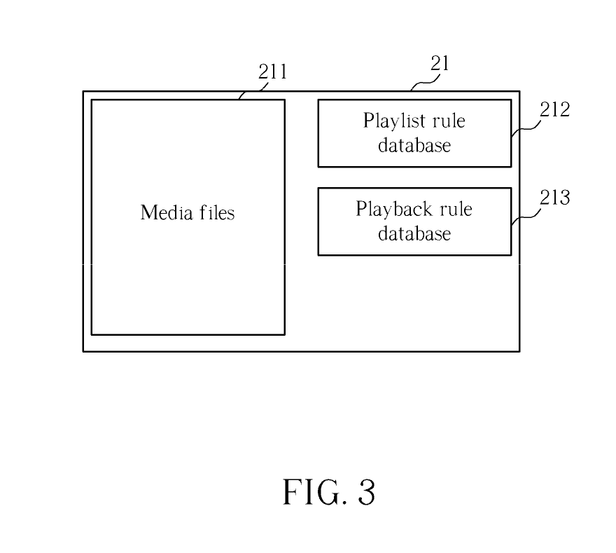

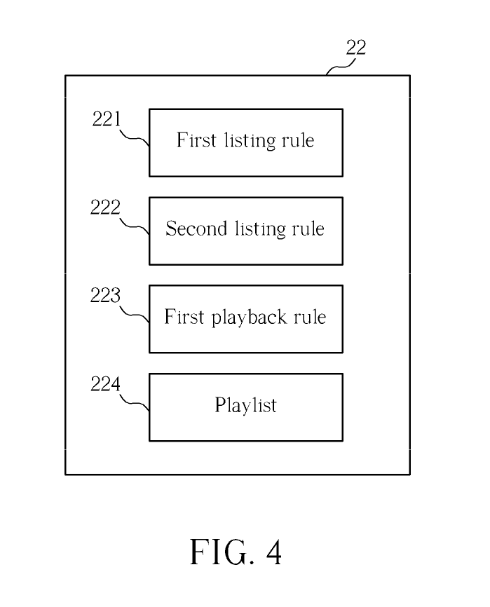

Please refer to FIG. 3 and FIG. 4. FIG. 3 is a block diagram of the first memory 21 of the portable device 1, and FIG. 4 is a block diagram of the second memory 22 of the portable device 1. The media playback method 100 and the portable device 1 disclosed in the invention let the user operate the user's interface 30 to decide the way to generate a playlist and to play the media files listing in the playlist. In this embodiment, the first memory 21 stores a plurality of media files 211, a playlist rule database 212, and a playback rule database 213, while in other embodiments, the playlist rule database 212 and the playback rule database 213 may also be program codes, or stored in a DRAM, which is a separate memory other than where the media files 211 and the file-directory system used for storing the media files 211 of the portable device 1. The playlist rule database 212 includes a plurality of pre-defined listing rules, for example, the first listing rule 221 or the second listing rule 222 in FIG. 4, for generating a playlist 224. The playback rule database 213 includes a plurality of pre-defined playback rules, such as the first playback rule 223 in FIG. 4, for determining how to play the media files listing in the generated playlist 224.

Additionally, the first memory 21 and the second memory 22 of the memory unit 20 disclosed in this embodiment may also be implemented by using two or more distinct sections of a same physical memory, such as a non-volatile random access memory (NVRAM). The first memory 21 and the second memory 22 are also unnecessary to locate at an independent physical memory. For example, at least one of the memories may locate at the cache memory of the processing unit 10. The listing rules 221, 222, the playback rule 223, and the playlist 224 may also be directly stored in the cache memory of the processing unit 10.

For example, the way of generating the playlist of the portable device 1 may be more than a few that within a file directory system, such as the one constantly adopted by windows operating system, when the user selects one media file via the user's interface 30 of the portable device 1, the selected media file is viewed by the portable device 1 as an anchor file, and the playlist rule database 212 may at least include the following listing rules:
1. Selecting all media files in the portable device 1;
2. Selecting media files in same folder as the anchor file;
3. Selecting media files in same folder including subfolders as the anchor file;
4. Selecting media files in sibling folders according to the anchor file; and
5. Selecting media files in sibling folders including subfolders according to the anchor file . . .

These listing rules may include the first listing rule 221 and the second listing rule 222 as previously described in FIG. 4. They may be pre-defined by manufacturer or defined by user and stored in the memory unit 20 of the portable device 1. The playback rule database 213 may at least include the following playback rules:
1. Playing the media files listing in the playlist sequentially, i.e., the normal mode;
2. Playing the media files listing in the playlist by repeatedly playing all media files, i.e., the repeat all mode;
3. Playing the anchor file repeatedly, the repeat one mode; and
4. Playing the media files listing in the playlist randomly, or the random mode . . .

Likewise, these playback rules may include the first playback rule 223 previously described in FIG. 4 They may also be pre-defined by manufacturer or defined by user and stored in the memory unit 20 of the portable device 1.

Please keep referring to FIG. 1 to FIG. 4. The media playback method 100 of the portable device 1 is described as followed:

Step 102: use the user's interface 30 of the portable device 1 to select a media file from the plurality of media files 211 as an anchor file.

Step 104: use the user's interface 30 to select the way to generate a playlist 224 (or by system default setting when the playlist 224 is generated without the user's selection). As described previously, the playlist rule database 212 includes a variety of listing rules stored in the first memory 21 of the memory unit 20. In this step, the user may configure the way to generate the playlist 224 by selecting the first listing rule 221 via the configuration menu (the user's interface 30) provided by the portable device 1. For the portable device 1, the processing unit 10 copies the first listing rule 221 selected by the user or by system's default setting from the playlist rule database 212 to the second memory 22 for follow-up generation of the playlist 224.

Step 106: select one or more media files from the plurality of media files 211 according to the selected anchor file in Step 102 and the selected listing rule (the first listing rule 221) in Step 104, and generate a playlist 224 according to the selected media files, where the generated playlist 224 is also stored in the second memory 22.

Step 108: use the user's interface 30 to select the way to play the media files listing in the playlist 224. The playback rule database 213 includes a variety of playback rules stored in the first memory 21 of the memory unit 20. In this step, the user may configure the way to play the playlist 224 by selecting the first playback rule 223 via the configuration menu (the user's interface 30) or by system default setting without user' configuring. For the portable device 1, the processing unit 10 copies the first playback rule 223 selected by the user to the second memory 22 for follow-up playback.

Step 110: play the media files 211 stored in the first memory 21 and also pointed by the playlist 224 according to the way of playing the media files configured in Step 108.

During the playback of the media files 211 in the portable device 1, a new playlist and the way to play the new playlist is also available for the user. When the playlist 224 is to be updated, Step 112: ‘obtain the currently played media file in the portable device 1 and set the obtained media file as the anchor file’ is performed. It should be noted that In FIG. 1, however, Step 112 to Step 120 can be carried out without necessarily following after the previous Step 102 to Step 110. In other words, Step 112 to Step 120 can also be implemented as a stand-along process disclosed in the media playback method according to the invention.

Step 114: use the user's interface 30 to re-select the way to generate a new playlist 224. The user may configure the way to re-generate the playlist 224 by selecting the second listing rule 222 (directly using the first listing rule 221 is also an option), via the configuration menu (the user's interface 30) provided by the portable device 1. For the portable device 1, the processing unit 10 copies the second listing rule 222 selected by the user from the playlist rule database 212 to the second memory 22 for generating a new playlist 224.

Step 116: select one or more media files from the plurality of media files 211 according to the newly selected anchor file in Step 112 and the selected second listing rule 222 in Step 114, and generate a new playlist 224 according to the selected media files, where the updated playlist 224 is also stored in the second memory 22.

Step 108: use the user's interface 30 to re-select the way to play the media files listing in the new playlist 224. In this step, the user may also decide whether or not to determine a new way to play the media files. If the user wants to adopt a new way to play the media files, he can re-select another playback rule via the configuration menu (the user's interface 30) provided by the portable device 1.

Step 120: play the media files 211 stored in the first memory 21 and also pointed by the updated playlist 224 according to the way of playing the media files configured in Step 118, or Step 108 if Step 118 is skipped.

Additionally, in Step 110 and Step 120, the anchor file in the playlist 224, either selected by the user or obtained from the currently played media file of the portable device 1, and all other media files selected, each is designated with a unique index value when listed in the playlist 224. As a result, playing the media files 221 stored in the first memory 21 and also pointed by the playlist 224 means the processing unit 10 of the portable device 1 will first obtain the index value of the anchor file in the playlist 224, then all media files listing in the playlist 224 will be played, starting from the anchor file and in a sequence by the index values and the playback rule configured in Step 108 or Step 118.

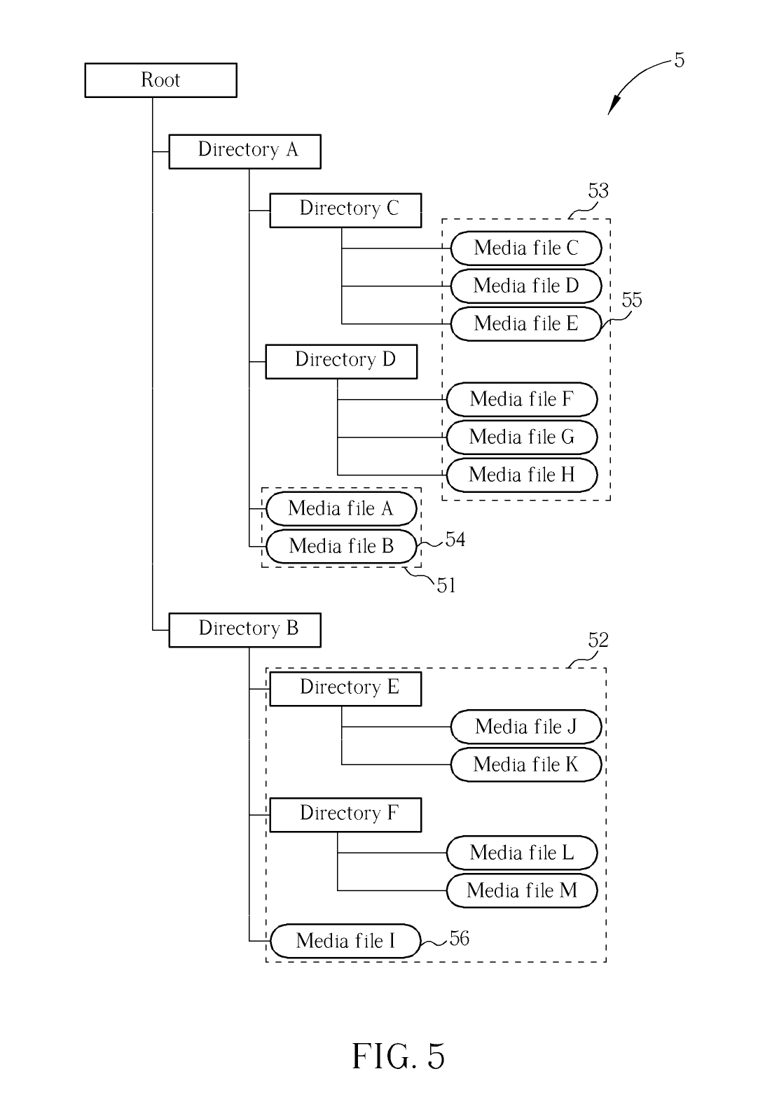

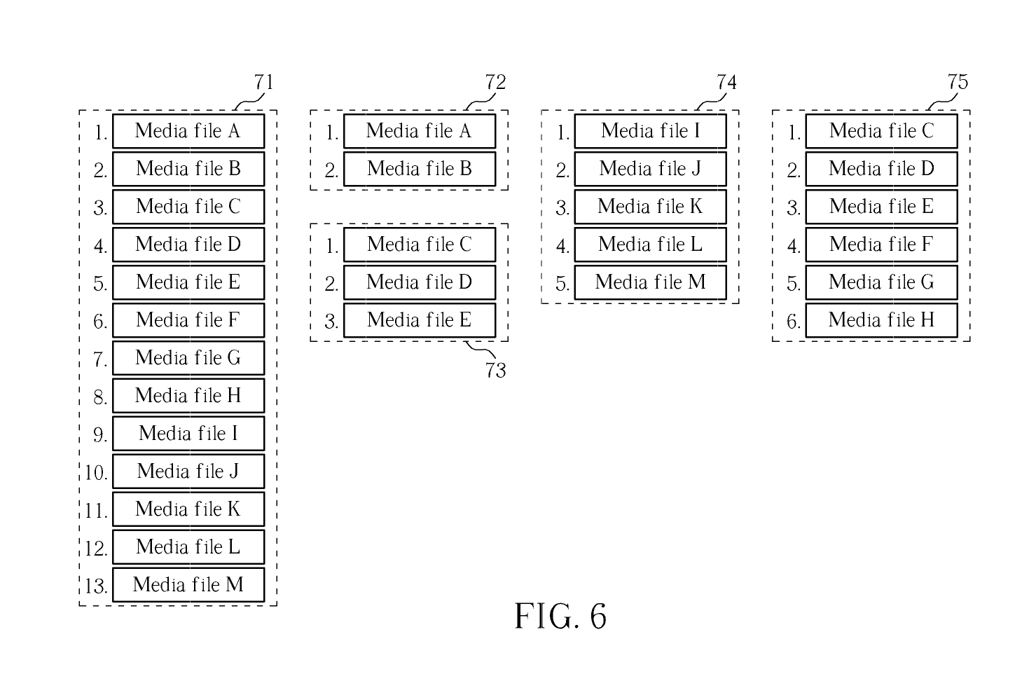

Practical examples are described in the following paragraphs for further description of the media playback method 100. Please note that the playback rule appeared in Step 108 or Step 118 is currently set as ‘playing the media files listing in the playlist sequentially’, or the normal mode, while other rules of playing the selected media files are skipped for brevity. As shown in FIG. 5 and FIG. 6, the media files are stored in the memory unit 20 based on the file directory system 5 in the portable device 1. For the Step 104 or Step 114 where the user configures the way to generate the playlist 224 via the configuration menu (the user's interface 30) of the portable device 1, the examples are as followed:

If the media file 54 is set to be the anchor file and the selected listing rule is ‘selecting all media files in the portable device 1’, a playlist 71 shown in FIG. 6 will be generated, which includes all media files in the portable device 1 and starts with the anchor file 54 (having index value 2);

If the media file 54 is set to be the anchor file and the selected listing rule is ‘selecting media files in same folder as the anchor file’, a playlist 72 shown in FIG. 6 will be generated, which includes media files A, B under the directory A (enclosed by the selection block 51) in the portable device 1 and starts with the anchor file 54 (having index value 2);

If the media file 55 is set to be the anchor file and the selected listing rule is ‘selecting media files in same folder as the anchor file’, a playlist 73 shown in FIG. 6 will be generated, which includes all media files under the directory C in the portable device 1 and starts with the anchor file 55 (having index value 3);

If the media file 56 is set to be the anchor file and the selected listing rule is ‘selecting media files in same folder including subfolders as the anchor file’, a playlist 74 shown in FIG. 6 will be generated, which includes media files under the directory B, and including subdirectories E and F (enclosed by the selection block 52) in the portable device 1 and starts with the anchor file 56 (having index value 1);

If the media file 55 is set to be the anchor file and the selected listing rule is ‘selecting media files in sibling folders according to the anchor file’, a playlist 75 shown in FIG. 6 will be generated, which includes media files under the directory C and directory D (same level as directory C and both enclosed by the selection block 53) in the portable device 1 and starts with the anchor file 55 (having index value 3);

If the media file 56 is set to be the anchor file and the selected listing rule is ‘selecting media files in sibling folders including subfolders according to the anchor file’, the playlist 71 shown in FIG. 6 will be generated under such rule, all media files in the portable device 1 included and started with the anchor file 56 (having index value 9).

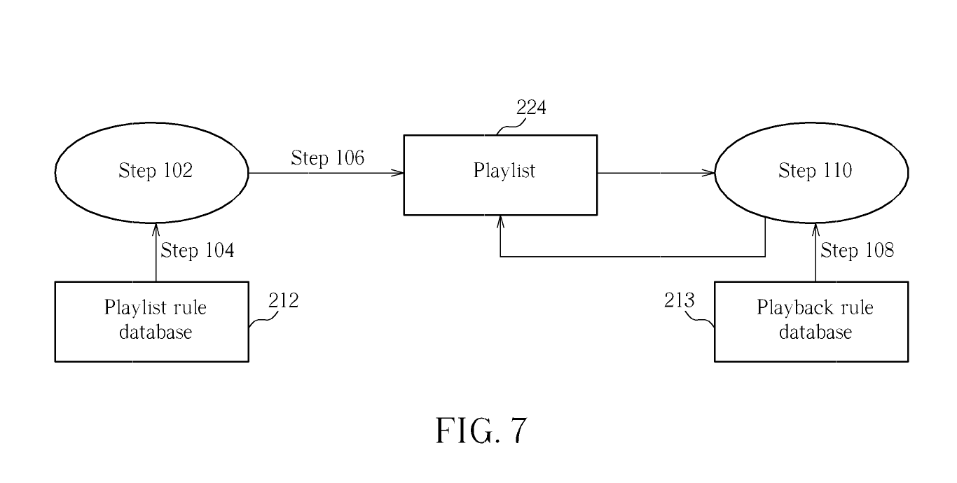

FIG. 7 is a schematic diagram showing the workflow of the media playback method 100 on the portable device 1.

The invention discloses a method for playing the media files and the portable device that implements the media playback method. Before the portable device playbacks the media files or during the playback of one media file, a rule of generating a playlist is selected first by operating a user's interface of the portable device or by the portable device's default setting. The playlist including some multiple media files is then generated according to an anchor file and the selected rule. A rule for how to play the media files in the playlist is selected (or by system's default setting if not selected) to decide the playing sequence of the media files in the playlist from the anchor file.

Those skilled in the art will readily observe that numerous modifications and alterations of the device and method may be made while retaining the teachings of the invention.

What is claimed is:

1. A media playback method for a portable device containing a plurality of media files, the method comprising following steps:
selecting an anchor file from the plurality of media files;
selecting a first listing rule from a playlist rule database;
generating a playlist by selecting media files from the plurality of media files according to the anchor file and the first listing rule; and
using the portable device to play the media files listing in the playlist according to a playback rule;
wherein the plurality of media files, the first listing rule, the playback rule, the playlist, and the playlist rule database are stored in a memory unit of the portable device, the portable device stores the plurality of media files based on a file directory system, and the playlist rule database comprises at least one listing rule from the following listing rules: selecting media files in same folder including subfolders as the anchor file, selecting media files in sibling folders according to the anchor file, and selecting media files in sibling folders including subfolders according to the anchor file.

2. The media playback method of claim 1, wherein selecting an anchor file from the plurality of media files comprises step:
setting a media file from the plurality of media files currently played by the portable device as the anchor file.

3. The media playback method of claim 1, wherein selecting an anchor file from the plurality of media files comprises step:
setting a media file selected from the plurality of media files by using a user's interface of the portable device as the anchor file.

4. The media playback method of claim 1, wherein the playlist rule database further comprises at least one listing rule from the following listing rules:
selecting all media files in the portable device, and selecting media files in same folder as the anchor file.

5. The media playback method of claim 1, wherein the first listing rule is selected from the playlist rule database by using a user's interface of the portable device.

6. The media playback method of claim 1, further comprising step:
updating the playlist by selecting media files from the plurality of media files according to the anchor file, and the first listing rule or a second listing rule.

7. The media playback method of claim 1, further comprising step:
selecting the playback rule from a playback rule database;
wherein the playback rule database is stored in the memory unit and comprises at least one playback rule from the following playback rules: playing the media files listing in the playlist sequentially, playing the media files listing in the playlist by repeatedly playing all media files, playing the anchor file repeatedly, and playing the media files listing in the playlist randomly.

8. The media playback method of claim 7, wherein the playback rule is selected from the playback rule database by using a user's interface of the portable device.

9. A portable device, comprising:
a memory unit storing a plurality of media files, a first listing rule, a first playback rule, and a playlist rule database; and
a processing unit used for selecting an anchor file from the plurality of media files, generating a playlist by selecting media files from the plurality of media files according to the anchor file and the first listing rule, and playing the media files listing in the playlist according to the first playback rule, wherein the playlist is stored in the memory unit;
wherein the plurality of media files is stored in the memory unit based on a file directory system, and the playlist rule database comprises at least one listing rule from the following listing rules: selecting media files in same folder including subfolders as the anchor file, selecting media files in sibling folders according to the anchor file, and selecting media files in sibling folders including subfolders according to the anchor file.

10. The portable device of claim 9, wherein the processing unit is used for setting a media file from the plurality of media files currently played by the portable device as the anchor file.

11. The portable device of claim 9, further comprising a user's interface for selecting a media file from the plurality of media files as the anchor file.

12. The portable device of claim 11, wherein the user's interface is buttons, a touch screen, a sensor, or a signal receiver of the portable device.

13. The portable device of claim 9, wherein the memory unit comprises a first memory and a second memory wherein the first memory stores the plurality of media files, the playlist rule database, and a playback rule database, and the second memory stores the first listing rule, the first playback rule, and the playlist.

14. The portable device of claim 13, wherein the first memory and the second memory are two distinct physical memories or two distinct sections of a physical memory.

15. The portable device of claim 13, wherein the at least one memory of the memory unit locates at a cache memory of the processing unit.

16. The portable device of claim 13, wherein the playlist rule database further comprises at least one listing rule from the following listing rules: selecting all media files in the portable device, and selecting media files in same folder as the anchor file.

17. The portable device of claim 13, further comprising a user's interface for selecting the first listing rule to be stored in the second memory from the playlist rule database.

18. The portable device of claim 13, wherein the playback rule database comprises at least one playback rule from the following playback rules: playing the media files listing in the playlist sequentially, playing the media files listing in the playlist by repeatedly playing all media files, playing the anchor file repeatedly, and playing the media files listing in the playlist randomly.

19. The portable device of claim 18, further comprising a user's interface for selecting the first playback rule to be stored in the second memory from the playback rule database.

20. The portable device of claim 13, wherein at least one memory of the memory unit is a flash memory.

21. The portable device of claim 9, wherein the plurality of media files is music files, still image files, or motion image files.
